(19) United States
(12) Patent Application Publication
(10) Pub. No.: US 2025/0349447 A1
(43) Pub. Date: Nov. 13, 2025

(54) METHOD FOR IMPROVING BREAKDOWN FIELD STRENGTH OF POLYETHYLENE BASED ON NANO-PARTICLES GRAFTED WITH VOLTAGE STABILIZER

(71) Applicant: Tianjin University, Tianjin (CN)

(72) Inventors: Yu GAO, Tianjin (CN); Baixin LIU, Tianjin (CN); Binyuan YE, Tianjin (CN); Boxue DU, Tianjin (CN)

(21) Appl. No.: 18/778,905

(22) Filed: Jul. 19, 2024

(30) Foreign Application Priority Data
May 8, 2024 (CN) 202410561661.5

(51) Int. Cl. H01B 3/44; C08K 3/36; C08K 9/06; C08L 23/06; C09C 1/30

(52) U.S. Cl. CPC H01B 3/441; C08K 3/36; C08K 9/06; C08L 23/06; C09C 1/3081; C01P 2004/64; C08K 2201/011; C08L 2203/202; C08L 2207/066

(57) ABSTRACT

The invention relates to a method for improving a breakdown field strength of polyethylene based on nano-particles grafted with a voltage stabilizer, comprising: 1) dehydration and condensation of nano-particles; 2) carboxyl activation of SDA; 3) grafting with SDA; and 4) preparation of modified nano-composite material. According to the invention, a surface of the nano-particles is modified by an organic group while improving a migration resistance capacity of the voltage stabilizer, and the obtained nano-particles grafted with the voltage stabilizer are doped into a polymer matrix material, so that an electrical property of the matrix material can be improved by both the nano-particles and the voltage stabilizer, and the improvement is stable; and a polyethylene nano-composite material with a significantly improved breakdown field strength can be obtained, thus improving an electrical property of an insulating material, and being beneficial for ensuring the stability of long-term operation of the insulating material.

### CROSS REFERENCE TO RELATED APPLICATIONS

This application claims foreign priority of Chinese Patent Application No. 202410561661.5, filed on May 8, 2024 in the China National Intellectual Property Administration, the disclosures of all of which are hereby incorporated by reference.

### TECHNICAL FIELD

The present invention belongs to the technical field of insulation of high-voltage direct current cables, and particularly relates to a method for improving a breakdown field strength of polyethylene based on nano-particles grafted with a voltage stabilizer.

### BACKGROUND OF THE PRESENT INVENTION

High-voltage direct current transmission is an important way to realize the flexible allocation and consumption of long-distance cross-regional electric energy, which has many advantages such as a low cost, a small loss and a long transmission distance. High-voltage direct current cable is key equipment of a direct current transmission system, which has a wide range of application scenarios and may be laid in various complex environments. Polyethylene has been widely used in power cables because of a high breakdown strength, a low dielectric loss, a high volume resistivity, an improved thermal property, a low cost, and other advantages. An insulation property of the polyethylene serving as a main cable insulating material is very important for cable safety. The cable insulating material should have an excellent insulation property to resist an effect of a strong electric field, thus ensuring long-term reliable operation of the cable. The improvement of the insulation property of the polyethylene can reduce an insulation thickness of the cable and improve a voltage level and a transmission capacity of the cable, thus being of great significance.

Researchers at home and abroad have obtained a certain research foundation by optimizing and improving the insulation property of the polyethylene by means of inorganic nano-particle doping, additive modification, and the like. The researchers found that nano-particles such as magnesium oxide (MgO), aluminum oxide (Al₂O₃), silicon dioxide (SiO₂) and graphene can be doped into a polymer as fillers, which can effectively improve a breakdown strength of the polymer, thus improving an insulation property of the polymer. The nano-particles have a small size effect and a huge specific surface area, so that after the nano-particles are added into a polymer material, the twining of a molecular chain can be changed, and a melting/crystallization behavior is affected. A large number of interfaces are introduced into the material, so that deep traps in the material are increased, the accumulation of space charges is inhibited, and an insulation property of PE is improved, thus prolonging the service life of cable insulation. However, a content, a size, surface modification and environmental conditions of the nano-particles will affect a modification effect. If the nano-particles have poor dispersion, there may be property instability or even deterioration of the composite material, leading to property decline in use. Therefore, it is generally necessary to modify a surface of the nano-particles by using an organic reagent, so as to prevent serious agglomeration when the nano-particles are blended into the polymer material, which affects the property of the matrix material. The voltage stabilizer is a small molecular additive often used for improving a dielectric property of the polymer material. The addition of the voltage stabilizer can help a polymer matrix to overcome electrical aging, improve an insulation resistance capacity to a high voltage, and improve a breakdown field strength. The voltage stabilizer is generally an aromatic compound with a benzene ring and a conjugated structure, which can capture high-energy electrons in the material under a strong electric field, reduce electron energy, and weaken an impact of the high-energy electrons on the molecular chain of the polymer insulating material, thus improving resistance capacities of the material to partial discharge and electrical treeing, and improving the direct current breakdown strength of the material. However, as a small molecular compound, the aromatic voltage stabilizer is easy to be migrated and precipitated from the polymer matrix, and may be dissipated with the long-term use of the insulating material, which is not conducive to the operation stability of cable insulation.

The nano-particles and the voltage stabilizer, serving as two additives widely used to improve an electrical property of the polymer insulating material, have also been compounded by the researchers to use. Researches show that the doping of the nano-particles and the voltage stabilizer into the polyethylene at the same time can play a synergistic role in property improvement, thus greatly improving the electrical property of the matrix. However, inherent shortcomings of the nano-particles and the voltage stabilizer caused by physical and chemical structures cannot be avoided only by simple physical blending for compounding and doping, which means that the poor dispersibility of the nano-particles and the migration of the voltage stabilizer with use will lead to property decline. In order to solve this problem, the nano-particles and the voltage stabilizer must be modified in chemical structure. Considering that there are a lot of dangling bonds on the surface of the nano-particles to make the nano-particles in an unstable state, the surface of the nano-particles may be modified by chemical grafting based on this characteristic.

Therefore, a new method for improving a breakdown field strength of polyethylene based on nano-particles grafted with a voltage stabilizer is studied and designed, which realizes the cooperative use of the nano-particles and the voltage stabilizer and gives consideration to the property optimization of the two additives, thus being applied to the insulation of the polyethylene direct current cable, and having a certain guiding significance for the selection and design of the cable insulating material in the future.

### SUMMARY OF THE PRESENT INVENTION

The present invention aims to overcome the shortcomings of the prior art, and to provide a method for improving a breakdown field strength of polyethylene based on nano-particles grafted with a voltage stabilizer, wherein doped nano-particles are grafted with a voltage stabilizer on surface and then subjected to end capping by an alkyl chain, so that the nano-particles and the voltage stabilizer synergistically improve a dielectric property.

The present invention solves the technical problem through the following technical solution.

A method for improving a breakdown field strength of polyethylene based on nano-particles grafted with a voltage stabilizer is provided, wherein the method comprises the following steps:
S1: selecting nano-particles with a purity greater than 99%, and dehydrating and condensing hydroxyl on a surface of the nano-particles by using a silane coupling agent γ-aminopropyl triethoxysilane KH550 to complete chemical bond connection, so as to form an intermediate carrier;
S2: selecting SDA as a voltage stabilizer, adding the SDA into a dimethyl sulfoxide DMSO solvent for uniform dispersion, and adding a catalyst tetramethylurea hexafluorophosphate HATU into the mixed solution to activate a carboxyl group of the SDA, so as to form an activation solution;
S3: adding the intermediate carrier in the S1 into the activation solution and carrying out ultrasonic treatment to uniformly disperse the intermediate carrier, magnetically stirring the mixture for full reaction at the same time, so that carboxyl on one side of the voltage stabilizer SDA is subjected to an amidation reaction with amino, and grafting the voltage stabilizer SDA on the surface of the nano-particles, so as to form nano-particle-SDA;
S4: washing, drying and grinding the reaction product nano-particle-SDA in the S3 for later use;
S5: adding the ground product of the SDA-grafted nano-particles in the S4 into the DMSO solution, adding the HATU to activate carboxyl on the other side of the SDA at the same time, selecting alkylamine for end capping of the SDA-grafted nano-particles through the amidation reaction, and washing and drying the reaction product after the reaction is completed; and
S6: adding the product in the S5 into low-density polyethylene and carrying out melt blending in a torque rheometer to obtain a modified nano-composite material.

Moreover, the intermediate carrier obtained in the S1 needs to be dried before adding into the activating solution, which specifically comprises pouring the intermediate carrier into a watch glass and drying in a vacuum drying oven for 3 hours at a drying temperature of 80° C.

Moreover, the reaction product nano-particle-SDA in the S3 is collected by centrifugal separation through a centrifuge and then washed with deionized water and anhydrous ethanol respectively, and then dried in a vacuum drying oven and ground.

Moreover, the low-density polyethylene in the S6 is washed with distilled water to remove impurities, then dried in a vacuum drying oven at 60° C. for 24 hours, and then subjected to melt blending with the product in the S5.

The present invention has the advantages and the beneficial effects as follows.

1. According to the method for improving the breakdown field strength of polyethylene based on the nano-particles grafted with the voltage stabilizer in the present invention, the aromatic small molecular voltage stabilizer is grafted on the surface of the nano-particles, an outer layer of the voltage stabilizer is subjected to end capping by using the alkyl chain, the modified nano-particles are doped into the polyethylene insulating material, the voltage stabilizer is modified on the surface of the nano-particles to avoid migration by using good migration resistance of the nano-particles, and then an outer end of the voltage stabilizer is connected with the alkyl chain to make the voltage stabilizer more compatible with LDPE; and according to the method, the surface of the nano-particles is modified by an organic group while improving a migration resistance capacity of the voltage stabilizer, and the obtained nano-particles grafted with the voltage stabilizer are doped into a polymer matrix material, so that an electrical property of the matrix material can be improved by both the nano-particles and the voltage stabilizer, and the improvement is stable, thus being beneficial for long-term use of cable insulation and being conductive to prolonging the service life of the cable.

2. According to the present invention, based on the nano-particles grafted with the voltage stabilizer, small molecules of the voltage stabilizer are fixed on the surface of the nano-particles through a chemical group on the surface of the nano-particles, and the modified nano-particles can prevent the small molecules of the voltage stabilizer from migrating from the matrix with use in combination with an effect of improving a dielectric property by the nano-particles and the voltage stabilizer, so that the dielectric property of polyethylene cable insulation can be greatly, stably and continuously improved, and the polyethylene cable insulation obtained by this method is more suitable for an application of an ultra-high-voltage direct current transmission system.

3. According to the present invention, after the SDA serving as the voltage stabilizer is grafted on the surface of the nano-particles, the SDA-grafted nano-particles are subjected to end capping by using the alkyl long chain, so that the breakdown field strength of the low-density polyethylene is improved by 30%, and as long as a grafting reaction effect and a doping process of subsequent melt blending are well controlled, a polyethylene nano-composite material with a significantly improved breakdown field strength may be obtained, so that this method improves the electrical property of the insulating material, is beneficial for ensuring the stability of long-term operation of the insulating material, and is conductive to improving the use safety of the direct current transmission cable.

### DESCRIPTION OF THE DRAWINGS

FIG. 1 is a flow chart of the present invention;

FIG. 2 is a schematic diagram of a nano-particle grafted with a voltage stabilizer in the present invention; and

FIG. 3 is a curve graph of Weibull distribution of direct current breakdown strengths of different samples.

### DETAILED DESCRIPTION OF PREFERRED EMBODIMENTS

The present invention is further described in detail hereinafter by the specific embodiments, the following embodiments are only descriptive, not restrictive, and cannot limit the scope of protection of the present invention.

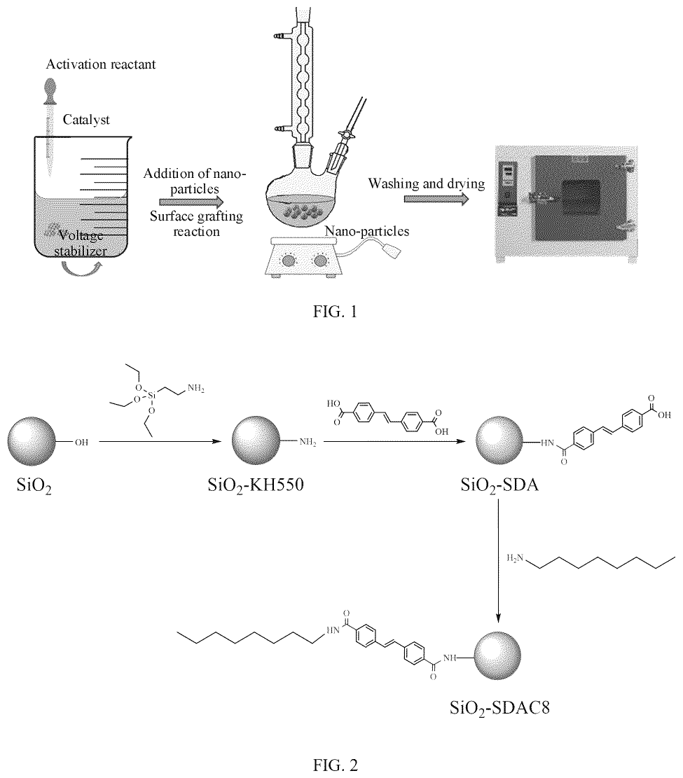

As shown in FIG. 1, a method for improving a breakdown field strength of polyethylene based on nano-particles grafted with a voltage stabilizer was innovative in that the method comprised the following steps.

1. SiO₂ nano-particles with a purity of 99% and a particle size of about 20 nm were selected, a silane coupling agent Y-aminopropyl triethoxysilane (KH550) was used to dehydrate and condense hydroxyl on a surface of the SiO₂ nano-particles to realize chemical bond connection, and amino at the other end could not only generate a hydrogen-bond interaction with a polymer to enhance an interface interaction, but also provide an intermediate carrier for further modification and grafting of the SiO₂ nano-particles.

2. SDA was selected as the voltage stabilizer for surface grafting, a molecular structure with a high conjugation effect of the SDA was beneficial for improving the property of cable insulation, and carboxyl at one end of the SDA could react with an amino group of the KH550 through an amidation reaction, so that the SDA was grafted on the SiO₂ nano-particles.

3. The SiO₂—KH550 was poured into a watch glass and dried in a vacuum drying oven at 80° C. for 3 hours to remove water.

4. 0. 75 of SDA the and 2.13 g of 2-(7-azabenzotriazole)-N,N,N′,N′-tetramethylurea hexafluorophosphate (HATU) were weighed, add into 100 ml of dimethyl sulfoxide (DMSO) solution, and ultrasonically treated for 15 minutes to activate the carboxyl.

5. 0.4 g of the dried SiO₂—KH550 was weighed, added into the solution, ultrasonically treated for 30 minutes for uniform dispersion, and magnetically stirred continuously at room temperature for 12 hours for full reaction.

6. The product was collected by centrifugal separation through a high-speed centrifuge (at 8000 rpm for 10 minutes), the product was dispersed in deionized water to be washed twice and then washed once in absolute ethanol, and the obtained reaction product (SiO₂-SDA) was dried in a vacuum drying oven at 80° C. for 12 hours and then ground for later use.

7. 0.6 g of the SiO₂-SDA was weighed, added into 100 ml of DMSO solution, and ultrasonically treated for 30 minutes, and after uniform dispersion of the particles, the mixture was added with 2 g of HATU, and ultrasonically treated for 15 minutes to activate the carboxyl.

8. After ultrasonic treatment, 1.2 mL of n-octyl amine was slowly dropwise added into the solution under constant stirring, and magnetically stirred continuously at room temperature for 12 hours. After full reaction, the product was collected by centrifugal separation through a high-speed centrifuge (at 8000 rpm for 10 minutes), washed and then dried to obtain alkyl-end capped SiO₂ nano-particles (SiO₂-SDAC8) grafted with the voltage stabilizer.

9. The LDPE particles were fully washed with distilled water to remove impurities, and then dried into a vacuum drying oven at 60° C. for 24 hours.

10. The prepared SiO₂-SDAC8 particles were doped into LDPE in a ratio of 3 wt %, jointly added into an internal mixer, and subjected to melt blending at a melting temperature set as 130° C. and a rotating speed set as 60 r/min for 6 minutes to obtain a modified nano-composite material.

According to the present invention, based on the nano-particles grafted with the voltage stabilizer, taking SiO₂ and SDA as an example, a schematic diagram of reaction was shown in FIG. 2, a large number of hydroxyls dangling on the surface of SiO₂ were mainly used in the reaction to react with a silane coupling agent, then amino was introduced, and the SDA was grafted on the surface of SiO₂ through an amidation reaction.

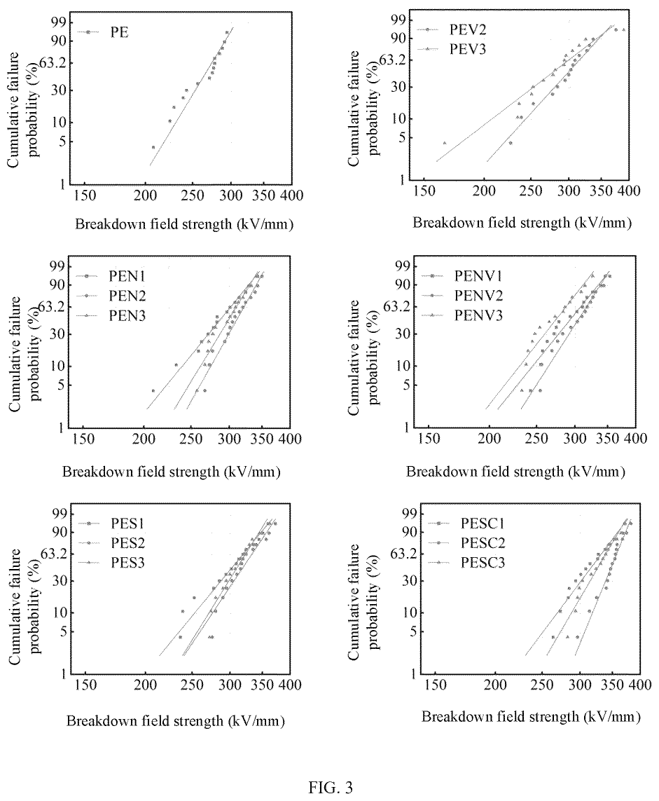

After SiO₂ before and after grafting modification was introduced into the LDPE matrix, numbers of samples were shown in Table 1, and an influence on a breakdown property of the LDPE matrix was shown in Table 2 and FIG. 3.

In FIG. 3, a to f were Weibull distribution curves of direct current breakdown strengths of a PE group, a PENV group, a PEN group, a PENV group, a PES group and a PESC group respectively. Test results showed that, compared with simple physical blending, SDA-grafted SiO₂ could improve the breakdown field strength of the LDPE more obviously, and achieve a stable effect. This improvement effect was further enhanced after end capping with alkylamine.

TABLE 1
Names and ingredients of samples

| | Ingredients | | | |
|---|---|---|---|---|
| | | | | Content of |
| | | Type of nano- | Content of nano- | voltage |
| Name | Matrix | particles | particles/wt % | stabilizer/wt % |
| PE | | | | |
| PEV2 | | | | 0.05 |
| PEV3 | | | | 0.15 |
| PEN1 | | SiO₂-KH550 | 0.5 | |
| PEN2 | | SiO₂-KH550 | 1 | |
| PEN3 | | SiO₂-KH550 | 3 | |
| PENV1 | | SiO₂-KH550 | 0.5 | 0.025 |
| PENV2 | LDPE | SiO₂-KH550 | 1 | 0.05 |
| PENV3 | | SiO₂-KH550 | 3 | 0.15 |
| PES1 | | SiO₂-SDA | 0.5 | |
| PES2 | | SiO₂-SDA | 1 | |
| PES3 | | SiO₂-SDA | 3 | |
| PESC1 | | SiO₂-SDAC8 | 0.5 | |
| PESC2 | | SiO₂-SDAC8 | 1 | |
| PESC3 | | SiO₂-SDAC8 | 3 | |

TABLE 2
Weibull distribution parameters of direct
current breakdown strengths of samples

| Name | Scale parameter α (kV/mm) | Shape parameter β |
|---|---|---|
| PE | 273.47 | 13.22 |
| PEV2 | 315.06 | 8.76 |
| PEV3 | 298.95 | 6.13 |
| PEN1 | 301.36 | 9.79 |
| PEN2 | 321.03 | 14.29 |
| PEN3 | 309.70 | 13.19 |
| PENV1 | 307.81 | 9.88 |
| PENV2 | 316.36 | 12.50 |
| PENV3 | 287.05 | 10.20 |
| PES1 | 319.08 | 9.67 |
| PES2 | 332.94 | 11.93 |
| PES3 | 322.82 | 12.83 |
| PESC1 | 331.84 | 10.65 |
| PESC2 | 356.87 | 19.51 |
| PESC3 | 339.08 | 13.69 |

According to the present invention, in combination with the improvement of a dielectric property of polyethylene by the nano-particles and the voltage stabilizer, the breakdown field strength of the matrix material is greatly improved. Meanwhile, the grafting reaction can improve the migration resistance of the voltage stabilizer, so as to avoid the voltage stabilizer from migrating from the polymer matrix in long-term use to lead to the property decline of the composite material in long-term use. Moreover, the compatibility between the nano-particles and the polymer matrix can be improved through secondary grafting. Theoretical analysis and experiments prove that the studied modification method of grafting the voltage stabilizer on the surface of the nano-particles by grafting reaction can be realized, and there is obvious improvement effect on the breakdown field strength of the polyethylene matrix. This method provides a new scheme for the selection and design of the insulating materials for the polyethylene high-voltage direct current cable in the future.

Although the embodiments and the drawings of the present invention have been disclosed for illustrative purposes, those skilled in the art may understand that various alternatives, changes and modifications are possible without departing from the spirit and scope of the present invention and the appended claims. Therefore, the scope of the present invention is not limited to the contents disclosed in the embodiments and the drawings.

We claim:

1. A method for improving a breakdown field strength of polyethylene based on nano-particles grafted with a voltage stabilizer, wherein the method comprises the following steps:
S1: selecting nano-particles with a purity greater than 99%, and dehydrating and condensing hydroxyl on a surface of the nano-particles by using a silane coupling agent γ-aminopropyl triethoxysilane KH550 to complete chemical bond connection, so as to form an intermediate carrier;
S2: selecting SDA as a voltage stabilizer, adding the SDA into a dimethyl sulfoxide DMSO solvent for uniform dispersion, and adding a catalyst tetramethylurea hexafluorophosphate HATU into the mixed solution to activate a carboxyl group of the SDA, so as to form an activation solution;
S3: adding the intermediate carrier in the S1 into the activation solution and carrying out ultrasonic treatment to uniformly disperse the intermediate carrier, magnetically stirring the mixture for full reaction at the same time, so that carboxyl on one side of the voltage stabilizer SDA is subjected to an amidation reaction with amino, and grafting the voltage stabilizer SDA on the surface of the nano-particles, so as to form nano-particle-SDA;
S4: washing, drying and grinding the reaction product nano-particle-SDA in the S3 for later use;
S5: adding the ground product of the SDA-grafted nano-particles in the S4 into the DMSO solution, adding the HATU to activate carboxyl on the other side of the SDA at the same time, selecting alkylamine for end capping of the SDA-grafted nano-particles through the amidation reaction, and washing and drying the reaction product after the reaction is completed; and
S6: adding the product in the S5 into low-density polyethylene and carrying out melt blending in a torque rheometer to obtain a modified nano-composite material.

2. The method for improving the breakdown field strength of polyethylene based on the nano-particles grafted with the voltage stabilizer according to claim 1, wherein the intermediate carrier obtained in the S1 needs to be dried before adding into the activating solution, which specifically comprises pouring the intermediate carrier into a watch glass and drying in a vacuum drying oven for 3 hours at a drying temperature of 80° C.

3. The method for improving the breakdown field strength of polyethylene based on the nano-particles grafted with the voltage stabilizer according to claim 1, wherein the reaction product nano-particle-SDA in the S3 is collected by centrifugal separation through a centrifuge and then washed with deionized water and anhydrous ethanol respectively, and then dried in a vacuum drying oven and ground.

4. The method for improving the breakdown field strength of polyethylene based on the nano-particles grafted with the voltage stabilizer according to claim 1, wherein the low-density polyethylene in the S6 is washed with distilled water to remove impurities, then dried in a vacuum drying oven at 60° C. for 24 hours, and then subjected to melt blending with the product in the S5.
